(19) United States
(12) Patent Application Publication
(10) Pub. No.: US 2003/0044178 A1
(43) Pub. Date: Mar. 6, 2003

(54) Method for the automatic detection of red-eye defects in photographic image data

(76) Inventors: Knut Oberhardt, Foeching (DE); Gudrun Taresch, Munich (DE); Friedrich Jacob, Munich (DE); Tobias Damm, Munich (DE); Hans-Georg Schindler, Holzkirchen (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/192,712

(22) Filed: Jul. 9, 2002

(30) Foreign Application Priority Data
Sep. 3, 2001 (EP) 01121102.6

(51) Int. Cl. G03B 15/03

(52) U.S. Cl. 396/158

(57) ABSTRACT

A method for the automatic detection of red-eye defects in photographic image data includes the step of determining a value that provides information about the presence of a flash when recording the image data, as a criterion for the presence of such defects.

### BACKGROUND OF THE INVENTION

The invention relates to a method for detecting red-eye defects in photographic image data.

Such methods are known from various electronic applications that deal with digital image processing.

Semi-automatic programs exist for the detection of red eyes, where the user has to mark the region that contains the red eyes on an image presented by a PC. The red error spots are then automatically detected and a corrective color that resembles the brightness of the eye is assigned and the correction is carried out automatically.

However, such methods are not suited for automatic photographic developing and printing machines, where many images have to be processed very quickly in succession, leaving no time to have each individual image viewed, and if necessary marked by the user.

For this reason, fully automatic methods have been developed for the use in automatic photographic developing and printing machines.

For example, EP 0,961,225 describes a program comprised of several steps for detecting red eyes in digital images. Initially, areas exhibiting skin tones are detected. In the next step, ellipses are fit into these detected regions with skin tones. Only those regions, where such ellipse areas can be fitted, will then be considered candidate regions for red eyes. Two red eye candidates are than sought within these regions, and their distance—as soon as determined—is compared to the distance of eyes. The areas around the red eye candidates that have been detected as potential eyes are now compared to eye templates to verify that they are indeed eyes. If these last two criteria are met as well, it is assumed that red eyes have been found. These red eyes are then corrected.

The disadvantage of this program for detecting red eyes is that, in particular, the comparisons with the eye templates are very computing time intensive making it unsuitable for high performance photographic developing and printing machines.

### SUMMARY OF THE INVENTION

It is, therefore, a principal objective of the present invention to provide a method for the automatic detection of red eyes, where the analysis of the image data is carried out in a time frame that is suitable for automatic photographic developing and printing machines.

This objective, as well as other objectives which will become apparent from the discussion that follows, is achieved, in method for the automatic detection of red-eye defects in photographic image data, which includes the step of determining a value that provides information about the presence of a flash when recording the image data, as a criterion for the presence of such defects.

According to the invention, within the scope of the method for detecting red-eye defects, it will be analyzed whether the light of a camera flash has dominated when taking the picture. A dominating light of a flash is a prerequisite for the occurrence of red-eye defects.

This is a very reliable criterion, since red-eye defects occur only in images, when taking a picture of a person or animal, and the flash is reflected in the fundus (background) of the eye. However, the absence of a flash in an image can only be determined directly if the camera has set so-called “flash markers” when taking the picture. APS or digital cameras are capable of setting such markers that indicate whether a flash has been used or not. If a flash marker has been set that signifies that no flash has been used when taking the picture, it can be assumed with great reliability that no red-eye defects occur in the image.

With the majority of images having no such flash markers set, it can be concluded only indirectly, whether a flash picture is present or not. This can be determined, for example, by using an image analysis. In such an analysis, one may look for strong shadows of persons on the background, where the outline of the shadow corresponds to that of the outline of the face, however, the area exhibits a different color or image density. As soon as such very dominant hard shadows are present, it can be assumed with great probability that a flash has been used when taking the picture.

When it is determined that the image is very poor in contrasts, it is an indication that no flash has been used when taking the picture. The determination that the image is an artificial light image, that is, an image that exhibits the typical colors of lighting of an incandescent lamp or a fluorescent lamp, also indicates that no or no dominant flash has been used. A portion of the analysis that is carried out to determine if a flash has been used or not can already be done based on the so-called pre-scan data (the data arising from pre-scanning). Typically, when scanning photographic presentations, a pre-scan is performed prior to the actual scanning that provides the image data. This pre-scan determines a selection of the image data in a much lower resolution. Essentially, these pre-scan data are used to optimally set the sensitivity of the recording sensor for the main scan. However, they also offer, for example, the possibility to determine the existence of an artificial light image or an image poor in contrasts, etc.

These low-resolution data lend themselves very well to the analysis of exclusion criteria because their analysis does not require much time due to the small data set. Such exclusion criteria serve the purpose of ruling out red-eye defects from the outset such that the process for detecting red-eye defects can be terminated automatically. This can save much computing time. Such exclusion criteria can be, for example, the existence of photos where definitely no flash was used, or the absence of any larger areas with skin tones or a sharp drop in the Fournier transformed signals of the image data, indicating the absence of any detailed information in the image, that is, a very homogeneous image. Also all other criteria used for the detection of red eyes that can be checked quickly and that reliably provide the exclusion of images without red-eye defects can be used as exclusion criteria. For example, the fact that no red tones or no color tones at all are present in the entire image information may be used as an exclusion criterion. One of the most advantageous exclusion criteria, however, is the absence of a flash when taking a picture, because most of the time this can be verified very reliably and quickly.

If only one scan of the images is carried out or if only high-resolution digital data are present, it is advantageous to combine these data to low-resolution data for the purpose of checking the exclusion criteria. This can be done using an image raster, mean value generation or a pixel selection.

To increase the reliability of the assertion about the presence of a flash picture or the absence of a flash when the picture has been taken, it is advantageous to check several of the criteria mentioned here and to combine the results obtained when checking the individual criteria to an overall result and an assertion about the use of a flash. To save computing time, it is advantageous here is well to analyze the criteria simultaneously. The evaluation may be carried out using probabilities or a neural network as well.

To use the fact that a flash has been used when taking the picture as a criterion or a prerequisite for the presence of red-eye defects in the course of the detection process is particularly advantageous, because it is a criterion that is relatively easily checked and that is very meaningful. This criterion can be used in place of other very time-consuming criteria. Since it can be analyzed using auxiliary film data or greatly reduced image data, it can be analyzed easily under application of little computing capacity and time. An independent or possibly simultaneous analysis of signs or criteria is described in greater detail using the exemplary embodiment.

For a full understanding of the present invention, reference should now be made to the following detailed description of the preferred embodiments of the invention as illustrated in the accompanying drawing.

### BRIEF DESCRIPTION OF THE DRAWING

FIG. 1, comprised of FIGS. 1A, 1B and 1C, is a flowchart of an exemplary embodiment of the method according to the invention.

### DESCRIPTION OF THE PREFERRED EMBODIMENTS

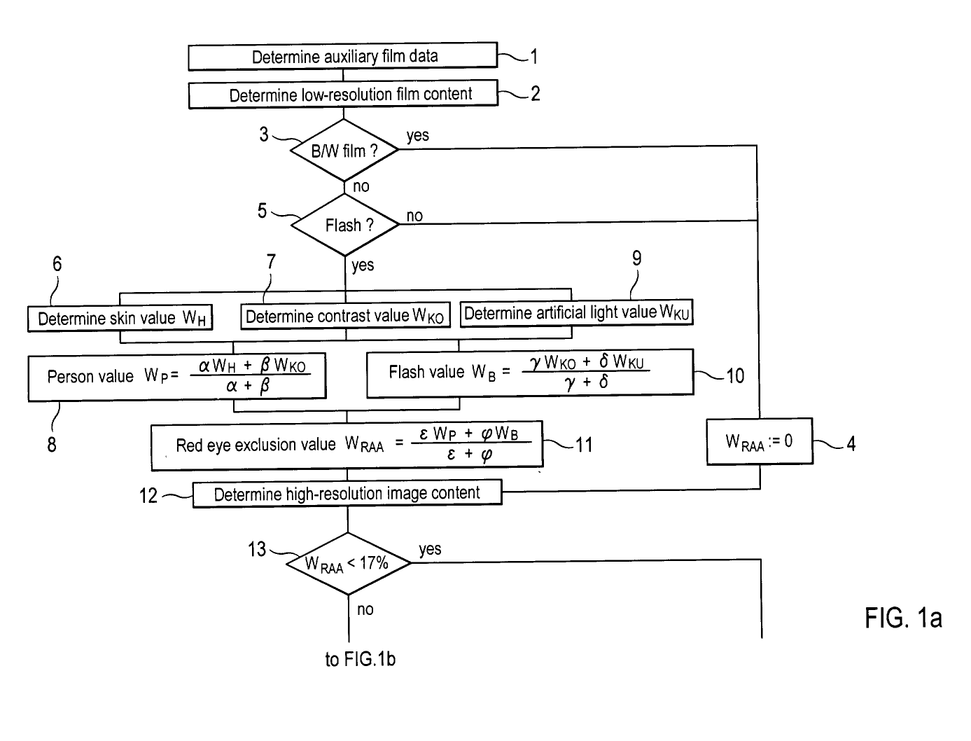

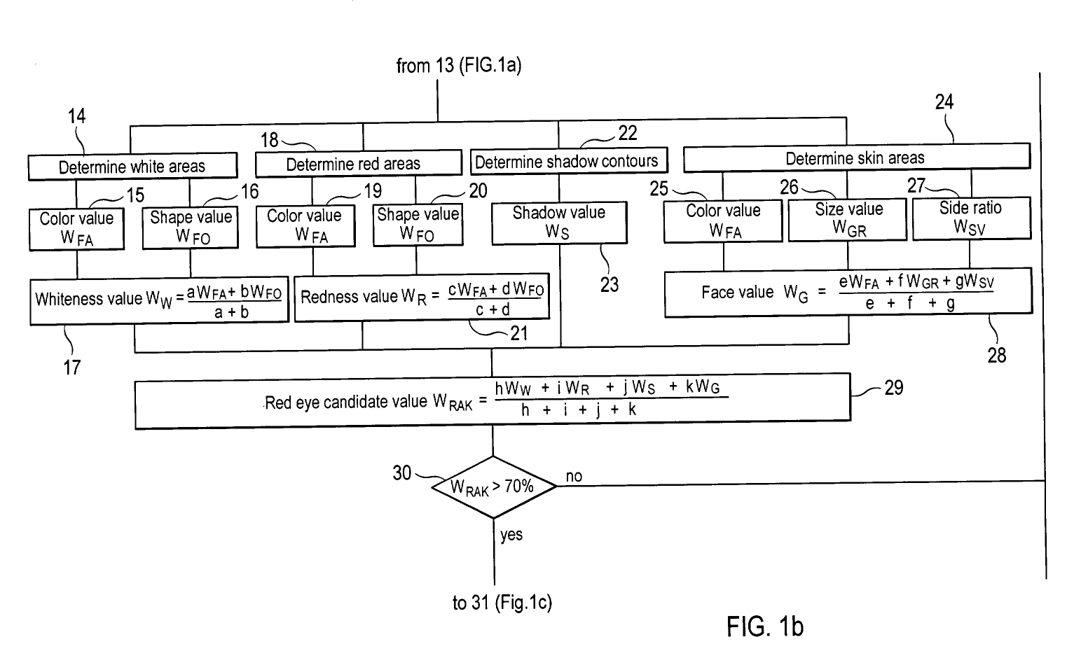

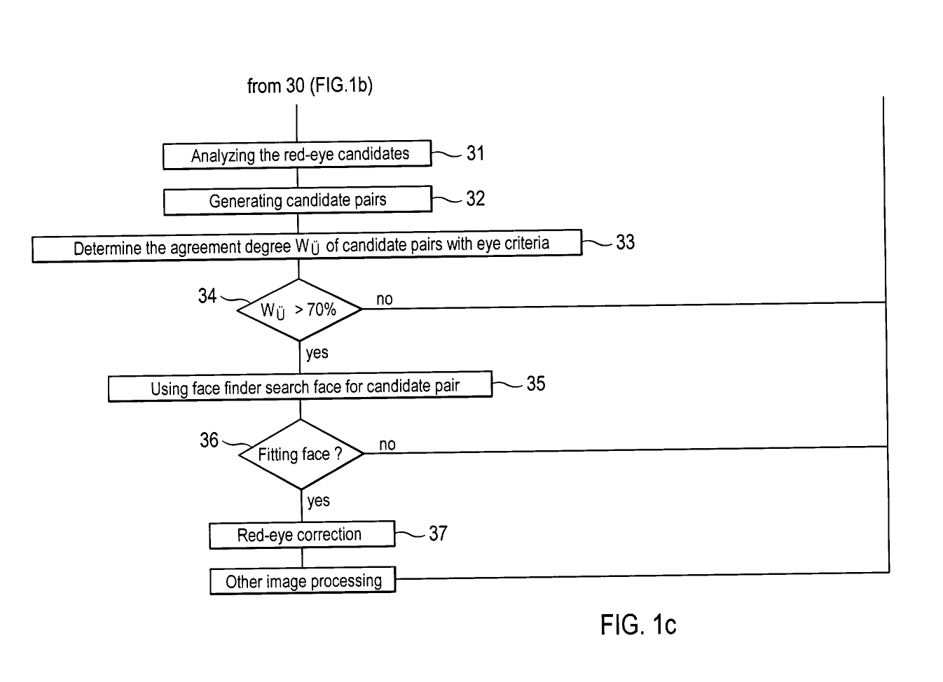

An advantageous exemplary embodiment of the invention will now be explained with reference to the flowchart of FIG. 1.

In order to analyze image data for red-eye defects, the image data must first be established using a scanning device, unless they already exist in a digital format, e.g., when coming from a digital camera. Using a scanner, it is generally advantageous to read out auxiliary film data such as the magnetic strip of an APS film using a low-resolution pre-scan and to determine the image content in a rough raster. Typically CCD lines are used for such pre-scans, where the auxiliary film data are either read out with the same CCD line that is used for the image content or are collected using a separate sensor. The auxiliary film data are determined in a step 1, however, they can also be determined simultaneously with the low-resolution film contents, which would otherwise be determined in a step 2. The low-resolution image data can also be collected in a high-resolution scan, where the high-resolution data set is then combined to a low-resolution data set. Combining the data can be done, for example, by generating a mean value across a certain amount of data or by taking only every x^{th} high-resolution image point for the low-resolution image set. Based on the auxiliary film data, a decision is made in a step 3 or in the first evaluation step, whether the film is a black and white film. If it is a black and white film, the red-eye detection process is terminated, the red-eye exclusion value W_{RAA} is set to Zero in a step 4, the high-resolution image data are determined, unless they are already present from a digital data set, and processing of the high-resolution image data is continued using additional designated image processing methods. The process continues in the same manner if a test step 5 determines that a flash marker is contained in the auxiliary film data that indicates that no flash has been used when taking the picture. As soon as such a flash marker has determined that no flash has been used when taking the picture, no red-eye defects can be present in the image data set. Thus, here too the red-eye exclusion value Woo is set to Zero, the high-resolution image data are determined, and other, additional image processing methods are started. Using the exclusion criteria “black and white film” and “no flash when taking picture”, which can be determined from the auxiliary film data, images that reliably cannot exhibit red-eye defects are excluded from the red-eye detection process. Much computing time can be saved by using such exclusion criteria because the subsequent elaborate red-eye detection method no longer needs to be applied to the excluded images.

Additional exclusion criteria that can be derived from the low-resolution image content are analyzed in the subsequent steps. For example, in a step 6, the skin value is determined from the low-resolution image data of the remaining images. To this end, skin tones that are an indication that persons are shown in the photo are sought in the image data using a very rough raster. The contrast value determined in a step 7 is an additional indication for persons in the photo. With an image that is very low in contrasts, it can also be assumed that no persons have been photographed. It is advantageous to combine the skin value and the contrast value to a person value in a step 8. It is useful to carry out a weighting of the exclusion values “skin value” and “contrast value”. For example, the skin value may have a greater weight than the contrast value in determining whether persons are present in the image. The correct weighting can be determined using several images, or it can be found by processing the values in a neural network. The contrast value is combined with an artificial light value determined in step 9, which provides information whether artificial lighting—such as an incandescent lamp or a fluorescent lamp—is dominant in the image in order to obtain information whether the recording of the image data has been dominated by a camera flash. Contrast value and artificial light value generate a flash value in step 10.

If the person value and the flash value are very low, it can be assumed that no person is in the image and that no flash photo has been taken. Thus, the occurrence of red-eye defects in the image can be excluded. To this end, a red-eye exclusion value W_{RAA} is generated from the person value and the flash value in a step 11. It is not mandatory that the exclusion criteria “person value” and “flash value” be combined to a single exclusion value. They can also be viewed as separate exclusion criteria. Furthermore, it is imaginable to check other exclusion criteria that red-eye defects cannot be present in the image data.

When selecting the exclusion criteria, it is important to observe that checking these criteria must be possible based on low-resolution image data, because computing time can only be saved in a meaningful manner if very few image data can be analyzed very quickly to determine whether a red-eye detection method shall be applied at all or if such defects can be excluded from the outset. If checking the exclusion criteria were to be carried out using the high-resolution image data, the savings in computing time would not be sufficient to warrant checking additional criteria prior to the defect detection process. In this case, it would be more prudent to carry out a red-eye detection process for all photos. However, if the low-resolution image contents are used to check the exclusion criteria, the analysis can be done very quickly such that much computing time is saved, because the elaborate red-eye detection process based on the high-resolution data does not need to be carried out for each image.

If the image data are not yet present in digital format, the data of the high-resolution image content need now be determined from all images in a step 12. With photographic films, this is typically accomplished by scanning, using a high-resolution area CCD. However, it is also possible to use CCD lines or corresponding other sensors suitable for this purpose.

If the pre-analysis has determined that the red-eye exclusion value is very low, it can be assumed that no red-eye defects can be present in the image. The other image processing methods such as sharpening or contrast editing will be started without carrying out a red-eye detection process for the respective image. However, if in step 13 it is determined that red-eye defects cannot be excluded from the outset, the high-resolution image data will be analyzed to determine, whether certain prerequisites or indications for the presence of red-eye defects are at hand and the actual defect detection process will start.

It is advantageous that these prerequisites and/or indications are checked independent of one another. To save computing time, it is particularly advantageous to analyze them simultaneously. For example, in a step 14, the high-resolution image data are analyzed to determine, whether white areas can be found in them. A color value W_{FA} is determined for these white areas in a step 15, where said color value is a measure for how pure white these white areas are. In addition, a shape value W_{FO} is determined in step 16 that indicates, whether these found white areas can approximately correspond to the shape of a photographed eyeball or a light reflection in an eye or not. Color value and shape value are combined to a whiteness value in step 17, whereby a weighting of these values may be carried out as well. Simultaneously, red areas are determined in a step 18 that are assigned color and shape values as well in steps 19 and 20, respectively. From these, the redness value is determined in a step 21. The shape value for red areas refers to the question, whether the shape of the found red area corresponds approximately to the shape of a red-eye defect.

An additional, simultaneously carried out step 22 determines shadow outlines in the image data. This can be done, for example, by searching for parallel running contour lines whereby one of these lines is bright and the other is dark. Such dual contour lines are an indication that a light source is throwing a shadow. If the brightness/darkness difference is particularly great, it can be assumed that the light source producing the shadow was the flash of a camera. In this manner, the shadow value reflecting this fact and determined in a step 23 provides information, whether the probability for a flash is high or not.

The image data are analyzed for the occurrence of skin areas in an additional step 24. If skin areas are found, a color value—that is, a value that provides information how close the color of the skin area is to a skin tone color—is determined from these areas in a step 25. Simultaneously, a size value, which is a measure for the size of the skin area, is determined in a step 26. Also simultaneously, the side ratio, that is, the ratio of the long side of the skin area to its short side, is determined in a step 27. Color value, size value and side ratio are combined to a face value in a step 28, where said face value is a measure to determine how closely the determined skin area resembles a face in color size and shape.

Whiteness value, redness value, shadow value and face value are combined to a red-eye candidate value W_{RAK} in a step 29. It can be assumed that the presence of white areas, red areas, shadow outlines and skin areas in digital images indicates a good probability that the found red areas can be valued as red-eye candidates if their shape supports this assumption. When generating this value for a red-eye candidate, other conditions for the correlation of whiteness value, redness value and face value may be entered as well. For example, a factor may be introduced that provides information, whether the red area and the white area are adjacent to one another or not. It may also be taken into account, whether the red and white areas are inside the determined skin area or are far away from it. These correlation factors can be integrated in the red-eye candidate value. An alternative to the determination of candidate values would be to feed color values, shape values, shadow value, size value, side ratio, etc. together with the correlation factors into a neural network and to obtain the red-eye candidate value from it.

Finally, the obtained red-eye candidate value is compared to a threshold in a step 30. If the value exceeds the threshold, it is assumed that red-eye candidates are present in the image. A step 31 then investigates, whether these red-eye candidates can indeed be red-eye defects. In this step, the red-eye candidates and their surroundings can, for example, be compared to the density profile of actual eyes in order to conclude, based on similarities, that the red-eye candidates are indeed located inside a photographed eye.

An additional option for analyzing the red-eye candidates is to search for two corresponding candidates with almost identical properties that belong to a pair of eyes. This can be done in a subsequent step 32 or as an alternative to step 31 or simultaneous to it. If this verification step is selected, only red-eye defects in faces photographed from the front can be detected. Profile shots with only one red eye will not be detected. However, since red-eye defects generally occur in frontal pictures, this error may be accepted to save computing time. If the criteria recommended in steps 31 and 32 are used for the analysis, a step 33 determines an agreement degree of the found candidate pairs with eye criteria. In step 34, the agreement degree is compared to a threshold in order to decide, whether the red-eye candidates are with a great degree of probability red-eye defects or not. If there is no great degree of agreement, it must be assumed that some other red image contents were found that are not to be corrected. In this case, processing of the image continues using other image processing algorithms without carrying out a red-eye correction.

However, if the degree of agreement of the candidates with eye criteria is relatively great, a face recognition process is applied to the digital image data in a subsequent step 35, where a face fitting to the candidate pair shall be sought. Building a pair from the candidates offers the advantage that the orientation of the possible face is already specified. The disadvantage is—as has already been mentioned—that the red-eye defects are not detected in profile photographs. If this error cannot be accepted, it is also possible to start a face recognition process for each red-eye candidate and to search for a potential face that fits this candidate. This requires more computing time but leads to a reliable result. If no face is found in a step 36 that fits the red-eye candidates, it must be assumed that the red-eye candidates are not defects, the red-eye correction process will not be applied and instead, other image processing algorithms are started. However, if a face can be determined that fits the red-eye candidates, it can be assumed that the red-eye candidates are indeed defects, which will be corrected using a typical correction process in a correction step 37. Methods using density progressions such as those commonly used for real-time people monitoring or identity control may be used as a suitable face recognition method for the analysis of red-eye candidates. As a matter of principle, however, it is also possible to use simpler methods such as skin tone recognition and ellipses fits. However, these are more prone to errors.

There has thus been shown and described a novel method for the automatic detection of red-eye defects in photographic image data which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for the automatic detection of red-eye defects in photographic image data, the improvement comprising the step of determining a value that represents the presence of a flash when taking a picture and recording the image data, as a criterion for the presence of such defects.

2. Method as set forth in claim 1, wherein the determining step comprises the step of determining the presence of a flash marker in recorded auxiliary film data as an indication of whether a flash has been used when taking a picture and recording the image data.

3. Method as set forth in claim 1, wherein the determining step comprises the step of determining the presence of an artificial light photograph as an indication that a flash was not the dominant light source when taking the picture.

4. Method as set forth in claim 1, wherein the determining step comprises the step of determining the presence of a picture low in contrast as an indication that no flash has been used when taking the picture.

5. Method as set forth in claim 1, wherein the determining step comprises the step of determining the presence of a result of an image analysis as an indication of whether a flash has been used when taking the picture.

6. Method as set forth in claim 5, wherein hard shadows in the image are an indication of whether a flash has been used when taking the picture.

7. Method as set forth in claim 1, wherein a plurality of processes to determine the use of a flash are carried out independently of one another.

8. Method as set forth in claim 7, wherein said plurality of processes are carried out simultaneously.

9. Method as set forth in claim 1, wherein a decision as to the presence of red-eye defects is made, based on an overall evaluation of said value, together with other values determined as criteria for the presence of such defects.

10. Method as set forth in claim 9, wherein the values are probabilities.

11. Method as set forth in claim 9, wherein the overall evaluation is made using a neural network.

12. Method as set forth in claim 1, wherein the process for automatic detection of red-eye defects is automatically terminated if it is determined that no flash has been used.
